(19) United States
(12) Patent Application Publication
(10) Pub. No.: US 2005/0024998 A1
(43) Pub. Date: Feb. 3, 2005

(54) Servo control method and servo control circuit, and optical disk device having the same servo control circuit

(76) Inventors: Yukio Inoue, Fukuoka (JP); Kazuyuki Yamaguchi, Fukuoka (JP); Taizou Kusano, Fukuoka (JP); Kazuhisa Hayashida, Fukuoka (JP); Yuichi Udo, Fukuoka (JP); Yuko Fujimoto, Fukuoka (JP); Hiromi Kuriyama, Fukuoka (JP); Takashi Ooishi, Fukuoka (JP); Yasuhiro Kaneo, Fukuoka (JP); Ryo Ando, Tokyo (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/900,337

(22) Filed: Jul. 28, 2004

(30) Foreign Application Priority Data
Jul. 31, 2003 (JP) P2003-284219
Aug. 5, 2003 (JP) P2003-287141
Aug. 5, 2003 (JP) P2003-287140

(51) Int. Cl. G11B 7/00

(52) U.S. Cl. 369/44.29; 369/44.34; 369/44.35; 369/44.32

(57) ABSTRACT

A servo error signal and a defect detection signal are generated from an output signal of the pickup unit, and a servo control signal and a hold signal are generated from the servo error signal. When changing to either a servo control signal or a hold signal based on the defect detection signal generated in a defect detection signal generation circuit which has a peak hold circuit having different tracking ability, so as to perform servo control of the pickup unit, a servo error signal predetermined time before a timing to change from the servo control signal to the hold signal is used as the servo error signal used for generation of the hold signal.

### BACKGROUND OF THE INVENTION

1. Field of the Invention

The present invention relates to a servo control method and a servo control circuit, and an optical disk device having the servo control circuit.

2. Description of the Related Art

In recent years, an optical disk has been used widely as a mass recording media which can record a lot of data.

A data recorded on this optical disk is reproduced in such a way that an input signal read from the optical disk by means of an optical disk playback apparatus is processed in a signal processing circuit.

In this case, the optical disk playback apparatus generates various control signals such as a tracking control signal and a focus control signal from the input signal read from the optical disk, and further generates a defect detection signal which indicates defects on the optical disk so as to control the internal circuits of the optical disk playback apparatus according to these control signals and defect detection signals.

As a defect detection signal generation circuit for generating such a defect detection signal, one such circuit that has a structure as shown in FIG. 14 is known (see Patent Document 1 as mentioned below, for example).

In other words, as shown in FIG. 14, a conventional defect detection signal generation circuit 101 has been constituted with a first peak hold circuit 102, a second peak hold circuit 103, a gain adjustment circuit 104, and a comparator circuit 105.

Here the first peak hold circuit 102 has quick tracking ability with respect to an input signal S101. In other words, it is arranged to have a circuit structure which can follow changes in the input signal S101 in a short time when the input signal S101 rises and falls, so as to output substantially the same detection signal S102 as the input signal S101.

On the other hand, the second peak hold circuit 103 has a slow tracking ability with respect to the input signal S101. In other words it has a circuit structure which is able to follow the changes in the input signal S101 in a short time when the input signal S101 rises, but takes predetermined time to follow the changes in the input signal S101 when the input signal S101 falls. It is arranged to output a detection signal S103 which rises in substantially the same way as the input signal S101, but falls more slowly than the input signal S101.

Further, the gain adjustment circuit 104 is a circuit which divides the voltage of the detection signal S103 detected at the second peak hold circuit 103 into 1/n thereof, and arranged to output a detection signal S1104 which is derived by dividing its voltage from the detection signal S103 into 1/n thereof.

The comparator circuit 105 is arranged to compare the detection signal S102 detected in the first peak hold circuit 102 with the detection signal S1104 detected in the second peak hold circuit 103, to output a signal of an “L” level as a defect detection signal S105 when the detection signal S102 is larger, and further to output a signal of an “H” level as the defect detection signal S105 when the detection signal S102 is smaller.

Then, the defect detection signal generation circuit 101 inputs the input signal S101 read from the optical disk by means of an optical pickup device into the first and second peak hold circuits 102, 103. When there is no defect on the optical disk, the detection signal S102 becomes larger than the detection signal S104, so that the signal of the “L” level is outputted as the defect detection signal S105. On the other hand, when there is a defect on the optical disk, the detection signal S1102 becomes smaller than the detection signal S104, so that the signal of the “H” level is outputted as the defect detection signal S105 (see FIG. 15-FIG. 17).

Further, in an optical disk device, in order to perform a feedback control of a reading point at a pickup unit, a servo control signal is generated from an output signal of the pickup unit, and a servo control circuit which outputs a servo control voltage for servo adjustment of the pickup unit based on the servo control signal is provided. The control is carried out by inputting the servo control voltage into a servo (see Patent Document 2 as mentioned below, for example).

In a case where abnormalities arise in the output signal of the pickup unit itself due to a crack produced on the disk or dust adhering to the disk, in order to prevent the servo from being controlled based on the abnormal output signal, the servo control circuit is provided with hold means which causes the servo to be in a hold state, when the abnormalities arise in the output signal of the pickup unit.

Referring now to FIG. 23 in particular, an RF signal read from a disk 600 by means of a pickup unit 500 is inputted into a reproduction circuit 700 while being inputted into a servo control circuit 400.

The servo control circuit 400 is constituted by an error signal generation circuit 410 for generating a servo error signal from the RF signal which is an output signal of the pickup unit 500, a defect detection signal generation circuit 420 for generating a defect detection signal from the RF signal, a servo control signal generation circuit 430 for generating a servo control signal based on the servo error signal, a hold signal generation circuit 440 for generating a hold signal holding a constant value acquired from the servo error signal subjected to a wave adjustment in this servo control signal generation circuit 430, and a servo control voltage output circuit 450 for outputting the servo control voltage based on the servo control signal or the hold signal.

Either the servo control signal or the hold signal is arranged to be inputted into the servo control voltage output circuit 450 by means of a changeover switch 460 based on a defect detection signal. In particular, when abnormalities arise in the output signal of the pickup unit 500, the servo is arranged to be in the hold state by inputting the hold signal into the servo control voltage output circuit 450.

Now, as shown in FIG. 24 the defect detection signal generation circuit 420 is constituted by an A/D converter circuit 421 for converting an analog RF signal, which is the output signal of the pickup unit 500, into a digital RF signal, a first peak hold circuit 422 for generating a primary peak hold signal of the digital RF signal, a second peak hold circuit 423 for generating a secondary peak hold signal from the primary peak hold signal, and a comparator circuit 424 for generating the defect detection signal based on the input of the primary peak hold signal and the secondary peak hold signal. A reference code 425 is a filter circuit provided for removing a pit component in the digital RF signal, and 426 is a gain adjustment circuit for the secondary peak hold signal.

In addition, another conventional example of the defect detection signal generation circuit is shown in FIG. 14.

The servo control signal generation circuit 430 stops its operation when the defect detection signal outputted from the defect detection signal generation circuit 420 is in “High” and holds status variables in the inside of the servo control signal generation circuit 430 as it is.
Patent Document 1: Japanese Laid-open Patent No. 2000-90446
Patent Document 2: Japanese Laid-open Patent No. 2000-90467

Now, the above-mentioned conventional defect detection signal generation circuit 101 may not generate the defect detection signal S105 correctly depending on some type of defects on the disk.

In other words, as for the defects on the disk, there are ones referred to as a dark defect, an interruption, and a bright defect.

The dark defect herein is a defect where an amount of reflection of light from the disk becomes significantly small under the influence of dust adhered to the disk surface at the time of data reading (see FIG. 15A).

Further, the interruption is a defect where an amount of reflection from the disk is a constant value at the time of data reading since a predetermined data was not recorded at the time of data writing (see FIG. 16A).

Still further, the bright defect is a defect where a signal of excessive amplitude is recorded under the influence of the dust adhering to the disk surface at the time of data writing, and the amount of reflection of the light from the disk becomes significantly large at the time of data reading (see FIG. 17A).

Among these defects, in the case of the dark defect, as shown in FIG. 15, since the detection signal S102 becomes smaller than the detection signal S104 in defective sections (see FIG. 15B), the correct defect signal S105 is generated in a defective section (see FIG. 15C).

However, in the case of the interruption, as shown in FIG. 16 the detection signal S102 becomes larger than the detection signal S104 also in the defective section (see FIG. 16B), and the defect signal S105 turns into the signal of the “L” level also in the defective section, so that the correct defect detection signal S105 cannot be generated (see FIG. 16C).

Further, in the case of the bright defect, as shown in FIG. 17, the detection signal S1102 becomes larger than the detection signal S104 also in the defective section (see FIG. 17B) and the defect detection signal S105 turns into a signal of the “L” level also in the defective section. Moreover, after passing the defective section, the detection signal S102 becomes smaller than the detection signal S1104 (see FIG. 17B), and the defect detection signal S105 turns into the signal of the “H” level after passing the defective section, so that the inaccurate defect detection signal S105 is generated (see FIG. 17C).

Thus, the conventional defect detection signal generation circuit 101 functions effectively only for the dark defect on the disk, and cannot generate the correct defect detection signal for the interruption or the bright defect.

Conventionally this does not cause a practical problem. When a general user uses the optical disk as a recording media, the vast majority of the use is only a playback use where recording of data on the optical disk is carried out in a clean room at a volume production factory and the general user only performs the data reproduction, so that the interruption or the bright defect due to a fault at the time of data writing occurs much less frequently.

However, in recent years since the recording media on which the general user can write a lot of data by himself or herself, such as write-once type optical disks (such as a CD-R and a DVD-R) and rewrite type optical disks (such as a CD-RW and a DVD-RW) have been widely used, the fault such as the dust adhering to the disk at the time of data writing may generate the interruption and the bright defect more frequently. If a defect detection signal is not correctly generated for these defects either, there is a possibility of a practical problem.

Further, in the above-mentioned servo control circuit, a time lag exists in the defect detection signal outputted from the defect detection signal generation circuit, so that a timing at which a signal to be inputted into the servo control voltage output circuit is changed from the servo control signal to the hold signal delays by predetermined time from a timing at which a change is produced in the output signal of the pickup unit and a fluctuation component is taken into the hold signal itself outputted from the hold signal generation circuit, whereby it is difficult to input a normal servo control voltage to the servo at the time of holding the servo.

Further, there is a problem that when operation of a servo control signal generation circuit is stopped based on the defect detection signal, the fluctuation component is taken in the status variables held in the servo control signal generation circuit.

Referring now to FIG. 25 in particular, when a crack or dust exists at the disk, a large change has arisen in the servo error signal generated from the output signal of the pickup unit as shown in FIG. 25A.

Thus, when the servo control signal generation circuit resumes its operation, since the servo control signal generation circuit may operate based on the status variables which have the fluctuation component, much of the time is taken by the time a normal servo control signal is outputted from the servo control signal generation circuit.

At this time, as shown in FIG. 25B, in the primary peak hold signal, a level fall arises in the level due to a level fall in the output signal of the pickup unit. On the other hand, since the secondary peak hold signal holds a normal value of the primary peak hold signal, the comparator circuit outputs the defect detection signal as shown in FIG. 25C by means of the primary peak hold signal and the secondary peak hold signal.

Here, the comparator circuit is provided with a preset threshold level. Since the defect detection signal is arranged to be “High” when the primary peak hold signal falls below the threshold level, a time period from the level of the primary peak hold signal starting to fall until it falls below the threshold level is a time lag t′.

Then, during this time lag t′, a change has already arisen in the servo error signal, so that when the hold signal generation circuit holds a constant value of the servo error signal and generates a hold signal based on the defect detection signal, the fluctuation component is to be taken also in the hold signal.

Thus, the time lag t′ is shortened by raising the threshold level so that the fluctuation component taken into the hold signal can be arranged to be smaller. In this case, the hold state of the servo may arise also for the dirt of the disk which does not have influence in playback operation, so that there is a possibility of affecting operational stability on the contrary.

### SUMMARY OF THE INVENTION

Thus, as for a servo control method of the present invention, in the servo control method of generating a servo error signal and a defect detection signal from an output signal of a pickup unit, generating a servo control signal and a hold signal from the servo error signal, and changing over to either the servo control signal or the hold signal based on the defect detection signal so as to perform servo control of the pickup unit, the hold signal is arranged to be generated from the servo error signal before a timing of performing changeover when changing the servo control signal to a hold signal.

Further, as for a servo control circuit of the present invention, in a servo control circuit for generating a servo control signal, for generating a hold signal and a defect detection signal from an output signal of a pickup unit, and changing over to either a servo control signal or a hold signal based on the defect detection signal so as to perform servo control of the pickup unit, a delay circuit is provided on an input side of a hold signal generation circuit for generating the hold signal. Furthermore, the defect detection signal generation circuit which generates the defect detection signal is characterized by having a changeover timing delay circuit which delays the timing to change the hold signal to the servo control signal based on the defect detection signal.

Moreover, as for an optical disk device having the servo control circuit of the present invention, in the optical disk device for generating a servo control signal, for generating a hold signal and a defect detection signal from an output signal of a pickup unit, and having the servo control circuit which changes over to either the servo control signal or the hold signal based on the defect detection signal, and performs servo control of the pickup unit, a delay circuit is provided on an input side of a hold signal generation circuit for generating the hold signal.

As for the servo control method of the present invention, in the servo control method of generating the servo control signal, for generating the hold signal and the defect detection signal from the output signal of the pickup unit, changing over to either the servo control signal or the hold signal based on the defect detection signal so as to perform the servo control of the pickup unit, when the status variables of the servo control signal generation circuit which generates the servo control signal is stored in a status variable memory circuit and the servo control signal is changed over to the hold signal, the servo control signal generation circuit is arranged to use a predetermined status variables out of the s stored in the status variable memory circuit.

Further, as for the servo control circuit of the present invention, in the servo control circuit for generating the servo control signal, for generating the hold signal and the defect detection signal from the output signal of the pickup unit, and changing over to either the servo control signal or the hold signal based on the defect detection signal so as to perform the servo control of the pickup unit, the servo control signal generation circuit which generates the servo control signal is connected to the status variable memory circuit which stores status variables of the servo control signal generation circuit, and the servo control signal generation circuit is arranged to use predetermined status variables out of the above-mentioned status variables stored in the status variable memory circuit when changing the servo control signal to the hold signal.

Furthermore, the status variables used by the servo control signal generation circuit are also characterized by having the status variables stored before, by predetermined time, the timing to change the servo control signal to the hold signal based on the defect detection signal. The defect detection signal generation circuit which generates the defect detection signal is characterized by having the changeover timing delay circuit which delays the timing to change the hold signal to the servo control signal based on a defect detection signal.

Still further, as for the optical disk device of the present invention, in the optical disk device for generating the servo control signal, for generating the hold signal and the defect detection signal from the output signal of the pickup unit, and having the servo control circuit which changes over to either the servo control signal or the hold signal based on the defect detection signal so as to perform the servo control of the pickup unit, the servo control signal generation circuit which generates the servo control signal is connected to the status variable memory circuit which stores the status variables of the servo control signal generation circuit, and the servo control signal generation circuit is arranged to use the predetermined status variables out of the status variables stored in the status variable memory circuit when changing the servo control signal to the hold signal.

Further, according to the present invention, it is decided that the defect detection signal generation circuit which generates the defect detection signal by means of the input signal read from the recording media, has a first and a second signal detection circuits where the tracking ability at the time of the rise and fall of the above-mentioned input signal differs with respect to the above-mentioned input signal and the first and second detection signals detected in the first and the second signal detection circuits are compared to generate the defect detection signal.

Still further, according to the present invention, it is decided that, as the above-mentioned first signal detection circuit, the first peak hold circuit is used which has quick tracking ability with respect to the above-mentioned input signal, and as the above-mentioned second signal detection circuit, the second peak hold circuit is used which has slow tracking ability with respect to the above-mentioned input signal.

Moreover, according to the present invention, it is decided that the above-mentioned first signal detection circuit includes the first peak hold circuit having the quick tracking ability with respect to the above-mentioned input signal, a first bottom hold circuit having the quick tracking ability with respect to the above-mentioned input signal, and a first difference circuit for detecting a difference between a detection signal in the above-mentioned first peak hold circuit and a detection signal in the above-mentioned first bottom hold circuit, and that the above-mentioned second signal detection circuit includes the second peak hold circuit having the slow tracking ability with respect to the above-mentioned input signal, the second bottom hold circuit having the slow tracking ability with respect to the above-mentioned input signal, and a second difference circuit for detecting a difference between the detection signal in the above-mentioned second peak hold circuit and the detection signal in the above-mentioned second bottom hold circuit.

Further, according to the present invention, as for an optical disk record/playback apparatus having a defect detection signal generation circuit which generates a defect signal by means of an input signal read from an optical disk, it is decided that the above-mentioned defect detection signal generation circuit includes a first and second signal detection circuits where tracking ability at the time of the rise and fall of the above-mentioned input signal differs with respect to the above-mentioned input signal, and the first and second detection signals detected in the first and the second signal detection circuits are compared to generate the defect detection signal.

In the servo control method of generating the servo error signal and the defect detection signal from the output signal of the pickup unit, generating the servo control signal and the hold signal from the servo error signal, and changing over to either the servo control signal or the above-mentioned hold signal based on the defect detection signal so as to perform the servo control of the pickup unit, when changing the servo control signal to the hold signal, the hold signal is generated from the servo error signal before the timing to change, so that a change component produced in the servo error signal is not taken in the generated hold signal during the time lag of the defect detection signal, thus generating the hold signal which can hold the servo of the pickup unit stably.

Further, in the servo control circuit for generating the servo control signal, for generating the hold signal and the defect detection signal from the output signal of the pickup unit, changing over to either the servo control signal or the hold signal based on the defect detection signal so as to perform the servo control of the pickup unit, the delay circuit is provided on the input side of the hold signal generation circuit for generating the hold signal, so that as with the invention as recited in one aspect of the invention change component produced in the servo error signal is not taken in the generated hold signal during the time lag of the defect detection signal, thus generating the hold signal which can hold the servo of the pickup unit stably.

Further, in the defect detection signal generation circuit which generates the defect detection signal, the changeover timing delay circuit is provided which delays the timing to change the hold signal to the servo control signal based on the defect detection signal, so that when the servo control of the pickup unit by means of the servo control signal is changed to the servo control by means of the hold signal, the servo control signal generation circuit resumes the generation of the servo control signal based on proper status variables, thus promptly outputting the normal servo control signal and stably performing the servo control immediately after returning from the hold state.

Furthermore, in the optical disk device for generating the servo control signal, for generating the hold signal and the defect detection signal from the output signal of the pickup unit, and having the servo control circuit which changes over to either the servo control signal or the hold signal based on the defect detection signal so as to perform the servo control of the pickup unit, the delay circuit is provided on the input side of the hold signal generation circuit for generating the hold signal, as with the invention as recited the aspect of the invention change component produced in the servo error signal is not taken in the generated hold signal during the time lag of the defect detection signal, thus generating the hold signal which can hold the servo of the pickup unit stably. Therefore, the operational stability of the optical disk device can be raised.

Still further, in the servo control method of generating the servo control signal, generating the hold signal and the defect detection signal from the output signal of the pickup unit, and changing over to either the servo control signal or the hold signal based on the defect detection signal so as to perform the servo control of the pickup unit, the status variables of the servo control signal generation circuit which generates the servo control signal is stored in the status variable memory circuit; the servo control signal generation circuit resumes the generation of the servo control signal based on the proper status variables, when changing from servo control of the pickup unit by means of the hold signal to the servo control by means of the servo control signal, so does the servo control signal generation circuit by means of the predetermined status variables out of the status variables stored in the status variable memory circuit when changing the servo control signal to the hold signal, thus promptly outputting the normal servo control signal and stably performing the servo control immediately after returning from the hold state.

Moreover, in the servo control circuit for generating the servo control signal, for generating the hold signal and the defect detection signal from the output signal of the pickup unit, changing over to either the servo control signal or the hold signal based on the defect detection signal so as to perform the servo control of the pickup unit, the servo control signal generation circuit which generates the servo control signal is connected to the status variable memory circuit which stores the status variables of the servo control signal generation circuit; when changing the servo control signal to the hold signal, the servo control signal generation circuit is arranged to use the predetermined status variables out of the above-mentioned status variables stored in the status variable memory circuit; when changing the servo control of the pickup unit by means of the hold signal to the servo control by means of the servo control signal, the servo control signal generation circuit resumes the generation of the servo control signal based on proper status variables, thus promptly outputting the normal servo control signal and stably performing the servo control immediately after returning from the hold state.

Further, the status variables used by the servo control signal generation circuit is arranged to be the status variables stored before, by predetermined time, the timing to change the servo control signal to the hold signal based on the defect detection signal, so that the fluctuation component of the output signal of the pickup unit is prevented from being taken in the status variables used by the servo control signal generation circuit and the status variables capable of generating the stable servo control signal can be used.

Furthermore, in the defect detection signal generation circuit which generates the defect detection signal, the changeover timing delay circuit is provided which delays the timing to change the hold signal to the servo control signal based on the defect detection signal, so that when the hold signal is changed to the servo control signal, the signal which has the fluctuation component can be prevented from being inputted into the servo control signal generation circuit, thus promptly outputting the normal servo control signal and stably performing the servo control immediately after returning from the hold state.

Still further, in the optical disk device for generating the servo control signal, for generating the hold signal and the defect detection signal from the output signal of the pickup unit, and having the servo control circuit which changes over to either the servo control signal or the hold signal based on the defect detection signal so as to perform the servo control of the pickup unit, the servo control signal generation circuit which generates the servo control signal is connected to the status variable memory circuit which stores the status variables of the servo control signal generation circuit; when changing the servo control signal to the hold signal, the servo control signal generation circuit is arranged to use the predetermined status variables out of the status variables stored in the status variable memory circuit; when changing the servo control of the pickup unit by means of the hold signal to the servo control by means of the servo control signal, the servo control signal generation circuit resumes the generation of the servo control signal based on the proper status variables, thus promptly outputting the normal servo control signal and stably performing the servo control immediately after returning from the hold state. Therefore, the operational stability of the optical disk device can be improved.

Further, in the defect detection signal generation circuit which generates the defect detection signal by means of the input signal read from the recording media, the first and second signal detection circuits are provided where the tracking ability with respect to the above-mentioned input signal at the time of the rise and fall of the above-mentioned input signal differs, and the first and second detection signals detected in the first and the second signal detection circuits are compared to generate the defect detection signal, so that even if a bright defect occurs at the time of playback operation, it is possible to prevent an erroneous defect detection signal from being generated.

Moreover, as the first signal detection circuit, the first peak hold circuit is used which has the quick tracking ability with respect to the above-mentioned input signal, and as the second signal detection circuit, the second peak hold circuit is used which has the slow tracking ability with respect to the above-mentioned input signal, so that even if a bright defect occurs at the time of playback operation, it is possible to prevent an erroneous defect detection signal from being generated only with a simple circuit.

Further, the first signal detection circuit includes, the first peak hold circuit having the quick tracking ability with respect to the input signal, the first bottom hold circuit having the quick tracking ability with respect to the input signal, and the first difference circuit which detects the difference between the detection signal in the first peak hold circuit and the detection signal in the first bottom hold circuit, in which the second signal detection circuit includes the second peak hold circuit having the slow tracking ability with respect to the input signal, the second bottom hold circuit having the slow tracking ability with respect to the input signal, and the second difference circuit which detects the difference between the detection signal in the second peak hold circuit and the detection signal in the second bottom hold circuit, so that the defect detection signal is correctly generated for the dark defect, the interruption, and the bright defect which have a possibility of being generated at the time of playback operation.

Furthermore, in the optical disk record/playback apparatus having the defect detection signal generation circuit which generates the defect detection signal by means of the input signal read from the optical disk, the above-mentioned defect detection signal generation circuit has the first and second signal detection circuits where the tracking ability with respect to the above-mentioned input signal at the time of the rise and fall of the above-mentioned input signal differs, the first and second detection signals detected in the first and the second signal detection circuits are compared to generate the defect detection signal, so that even if the bright defect occurs at the time of playback operation, it is possible to prevent an erroneous defect detection signal from being generated, thereby preventing a malfunction of optical disk record/playback apparatus.

### BRIEF DESCRIPTION OF THE DRAWINGS

FIG. 1 is a block diagram showing a reproduction circuit;

FIG. 2 is a diagram showing a recording media schematically;

FIG. 3 is a block diagram showing a variable A/D converter circuit;

FIG. 4 is a timing chart showing control of a switch;

FIG. 5 is a timing chart showing operation of the variable A/D converter circuit;

FIG. 6 is a block diagram showing a signal generation circuit;

FIGS. 7A to 7E are charts showing a detection signal at the time of a dark defect;

FIGS. 8A to 8E are charts showing the detection signal at the time of an interruption;

FIGS. 9A to 9E are charts showing the detection signal at the time of a bright defect;

FIG. 10 is a block diagram showing another signal generation circuit;

FIGS. 11A to 11F are charts showing the detection signal at the time of the dark defect;

FIGS. 12A to 12F are charts showing the detection signal at the time of the interruption;

FIGS. 13A to 13F are charts showing the detection signal at the time of the bright defect;

FIG. 14 is a block diagram showing a conventional defect detection signal generation circuit;

FIG. 15A to 15C are charts showing the detection signal at the time of the dark defect;

FIGS. 16A to 16C are charts showing the detection signal at the time of the interruption;

FIGS. 17A to 17C are charts showing the detection signal at the time of the bright defect;

FIG. 18 is a block diagram of a servo control circuit in accordance with the present invention;

FIG. 19 is a block diagram of a defect detection signal generation circuit;

FIGS. 20A to 20C are charts for explaining the defect detection signal generated in the defect detection signal generation circuit;

FIG. 21 is a block diagram for explaining the servo control signal generation circuit and a hold signal generation circuit in the servo control circuit;

FIG. 22 is a chart for explaining operation of a status variable memory circuit and the hold signal generation circuit;

FIG. 23 is a block diagram of a conventional servo control circuit;

FIG. 24 is a block diagram of a conventional defect detection signal generation circuit; and

FIGS. 25A to 25C are charts for explaining the defect detection signal generated in the conventional defect detection signal generation circuit.

### DESCRIPTION OF THE PREFERRED EMBODIMENTS

An optical disk record/playback apparatus in accordance with the present invention has a reproduction circuit therein for reproducing data recorded on an optical disk as a recording media.

This reproduction circuit has a single variable A/D converter circuit and a single signal generation circuit.

The variable A/D converter circuit herein is a circuit for converting a first and a second analog signals read from a first and a second record areas which differ from each other and are on a recording media, into a first and a second digital signals respectively with different sampling rates.

This variable A/D converter circuit connects the first and the second analog signals to an A/D converter circuit through the first and second switches, and is arranged to control these first and second switches by a control circuit which intermittently switches them with the different sampling rates.

Further, the signal generation circuit is a circuit for generating a first or a second reproduction signal which is different from each other, considering the first or the second digital signal as an input signal.

This signal generation circuit has the first and the second signal detection circuits where the tracking ability with respect to the above-mentioned input signal at the time of the rise and fall of the digital signal which is an input signal differs, and can be arranged to compare the first and second detection signals detected in the first and the second signal detection circuits so as to generate a reproduction signal.

For example, the signal generation circuit uses the first peak hold circuit having the quick (high) tracking ability with respect to the input signal as the first signal detection circuit, and may be arranged to use the second peak hold circuit having the slow (low) tracking ability with respect to the input signal as the second signal detection circuit.

Further, the signal generation circuit includes, as the first signal detection circuit, the first peak hold circuit having the quick (high) tracking ability with respect to the input signal, the first bottom hold circuit having the quick (high) tracking ability with respect to the input signal, and the first difference circuit which detects the difference between the detection signal in the first peak hold circuit and the detection signal in the first bottom hold circuit, while it may be arranged to include, as the second signal detection circuit, the second peak hold circuit having the slow (low) tracking ability with respect to an input signal, the second bottom hold circuit having the slow (low) tracking ability with respect to an input signal, and the second difference circuit which detects the difference between the detection signal in the second peak hold circuit and the detection signal in the second bottom hold circuit.

The first and second record areas are, for example, a data recording area, a burst cutting area, etc. In other words, the first record area is arranged to be a data recording area, and the second record area is arranged to be a burst cutting area, so that the defect detection signal may be reproduced as the first reproduction signal, and a burst cutting area signal may be reproduced as the second reproduction signal.

Thus, as the signal generation circuit, the first and the second signal detection circuits are provided where the tracking ability with respect to the input signal at the time of the rise and fall of the input signal differs, and when the first and the second detection signals detected in the first and the second signal detection circuits are compared to generate the reproduction signal, even if the bright defect occurs at the time of playback operation, it is possible to prevent an erroneous defect signal from being generated as the reproduction signal.

In particular, when the first peak hold circuit having the high tracking ability with respect to the input signal is used as the first signal detection circuit and the second peak hold circuit having the low tracking ability with respect to the input signal is used as the second signal detection circuit, even if the bright defect occurs at the time of playback operation, it is possible to prevent an erroneous defect detection signal from being generated as the reproduction signal only with a simple circuit, thereby preventing a malfunction of the optical disk record/playback apparatus.

Further, when the first signal detection circuit is arranged to include the first peak hold circuit having the high tracking ability with respect to the input signal, the first bottom hold circuit having the high tracking ability with respect to the input signal, and the first difference circuit which detects the difference between the detection signal in the first peak hold circuit and the detection signal in the first bottom hold circuit, while the second signal detection circuit is arranged to include the second peak hold circuit having the low tracking ability with respect to the input signal, the second bottom hold circuit having the low tracking ability with respect to the input signal, and the second difference circuit which detects the difference between the detection signal in the second peak hold circuit and the detection signal in the second bottom hold circuit is decided, it is possible to correctly generate the defect signal which is a reproduction signal with respect to the dark defect, the interruption, the bright defect which have a possibility of being generated at the time of playback operation.

Furthermore, when the reproduction circuit for reproducing the data recorded on the recording media is arranged to include the single variable A/D converter circuit for converting, into the first and the second digital signals, the first and the second analog signals read from the first and the second record areas which differ from each other and are on the recording media respectively with the different sampling rates, and the single signal generation circuit for generating the first or the second reproduction signal which differ from each other, considering the above-mentioned first or second digital signal as an input signal, it is not necessary to independently prepare the circuit for generating the first reproduction signal and the circuit for generating the second reproduction signal, so that these circuits can be constituted by a single circuit, whereby the circuit scale of the reproduction circuit which generates the first and the second reproduction signals can be reduced, thereby reducing labor, time, and costs necessary for manufacture of the optical disk playback apparatus which contains therein the reproduction circuit.

In particular, when the defect signal is reproduced as the first reproduction signal by arranging the first record area to be the data recording area, and the burst cutting area signal is reproduced as the second reproduction signal by arranging the second record area to be the burst cutting area, it is not necessary to independently prepare the defect detection signal generation circuit and the burst cutting area signal generation circuit, and these circuits can be constituted by a single circuit, thus reducing the circuit scale of the reproduction circuit which generates the defect signal and a burst cutting area signal.

Further, when the variable A/D converter circuit is arranged to connect the first and the second analog signals to the A/D converter circuit through the first and the second switches, and to control these first and second switches by the control circuit which intermittently switches them with the different sampling rates, the circuit scale of the variable A/D converter circuit can be reduced, so that the circuit scale of the reproduction circuit which generates the first and the second reproduction signals can be reduced further.

With reference to the drawings, a particular structure of the reproduction circuit which has a defect detection signal generation circuit in accordance with the present invention will be described hereafter. In addition, a defect detection signal generation circuit in accordance with the present invention may be applicable to various electric devices having a reproduction circuit which reproduces data recorded on a recording media represented by an optical disk playback apparatus, an optical disk record/playback apparatus, etc.

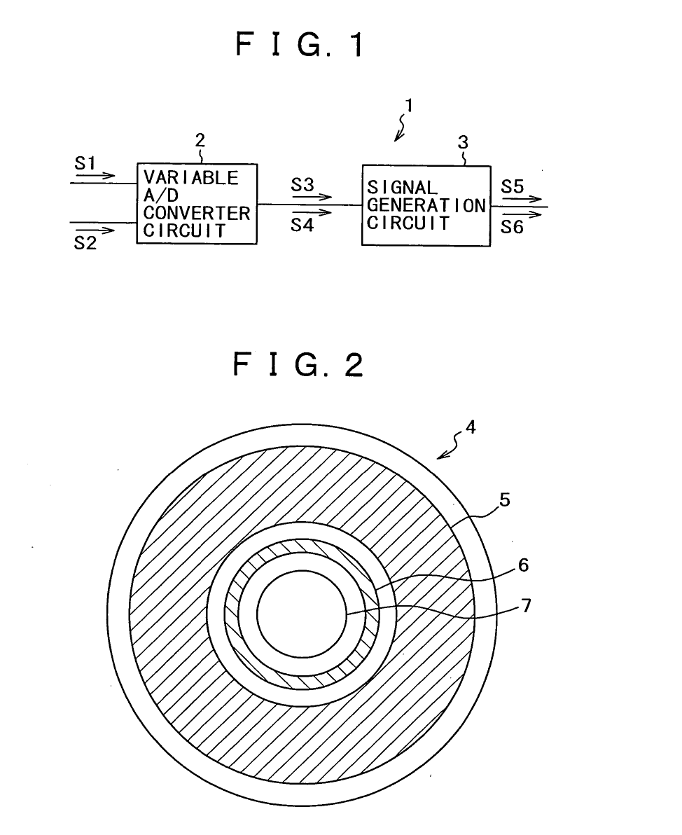

As shown in FIG. 1, a reproduction circuit 1 is constituted by a single variable A/D converter circuit 2 and a single signal generation circuit 3. Here in the reproduction circuit 1, a signal generation circuit 3 is a defect signal generation circuit in accordance with in accordance with the present invention.

The variable A/D converter circuit 2 is a circuit for converting a first and a second analog signals S1 and S2 into a first and a second digital signals S3 and S4 with different sampling rates, wherein the first and the second analog signals S1 and S2 are read from a first and a second record areas 5 and 6 which differ from each other and are on a recording media 4 as shown in FIG. 2 respectively.

Now, as shown in FIG. 2, a data recording area where the usual data written in the recording media 4 are recorded is used as the first record area 5. On the other hand, an area referred to as a burst cutting area (BCA: Burst Cutting Area) which records data for identifying each recording media 4 provided independently of the data recording area which records the usual data is used as the second record area 6. In addition, the burst cutting areas are concentrically formed around a center hole 7 of the recording media 4, where the data subjected to PE modulation (Phase Encoding modulation) are recorded as bar code data which are encoded by way of RZ (Return to Zero) system.

Further, the signal generation circuit 3 is a circuit for generating a first or a second reproduction signal S5 or S6 which is different from each other, considering the first or the second digital signal S3 or S4 generated in the variable A/D converter circuit 2 as an input signal.

Particular structures of the variable A/D converter circuit 2 and the signal generation circuit 3 will be described hereafter.

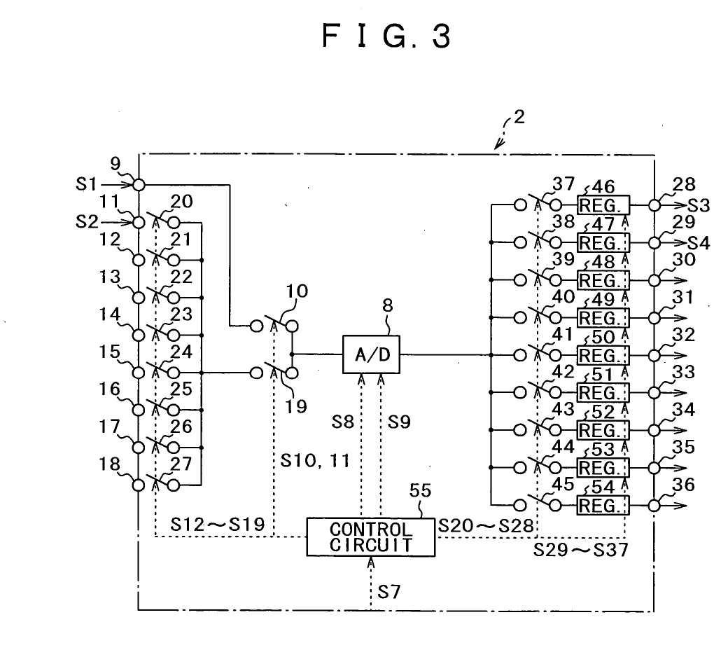

Firstly, a structure of the variable A/D converter circuit 2 will be described. As shown in FIG. 3, the variable A/D converter circuit 2 connects a channel 0 input terminal 9 to an analog input section of a one-input-one-output type A/D converter circuit 8 through a first switch 10, and connects a channel 1 input terminal 11 to a channel 8 input terminal 18 to the same analog input section through a second switch 19 and switches 20 to 27 provided for each channel.

Further, the variable A/D converter circuit 2 connects a channel 0 output terminal 28 to a channel 8 output terminal 36 to a digital output section of the A/D converter circuit 8 through switches 37 to 45 and registers 46 to 54.

Furthermore, the variable A/D converter circuit 2 connects a control circuit 55 to the A/D converter circuit 8 and all the switches 10, 19 to 27, and 37 to 45.

This variable A/D converter circuit 2 is arranged to have nine channels in order to raise versatility, input the first analog signal S1 into the channel 0 input terminal 9, and input the second analog signal S2 into the channel 1 input terminal 11 so as to output the first digital signal S3 through the channel 0 output terminal 28, and output the second digital signal S4 through the channel 1 output terminal 29.

The control circuit 55 is arranged to generate various types of control signals which are synchronized with a system clock signal S7 so as to control the A/D converter circuit 8 and switches 10, 19 to 27, and 37 to 45. Here, the control signal generated by the control circuit 55 may include an A/D clock signal S8 for driving the A/D converter circuit 8, a start flag signal S9 for starting conversion in the A/D converter circuit 8, switch control signals S10 to S28 for intermittently controlling switches 10, 19 to 27, and 37 to 45, and write enable signals S29 to S37 for writing data in the registers 46 to 54.

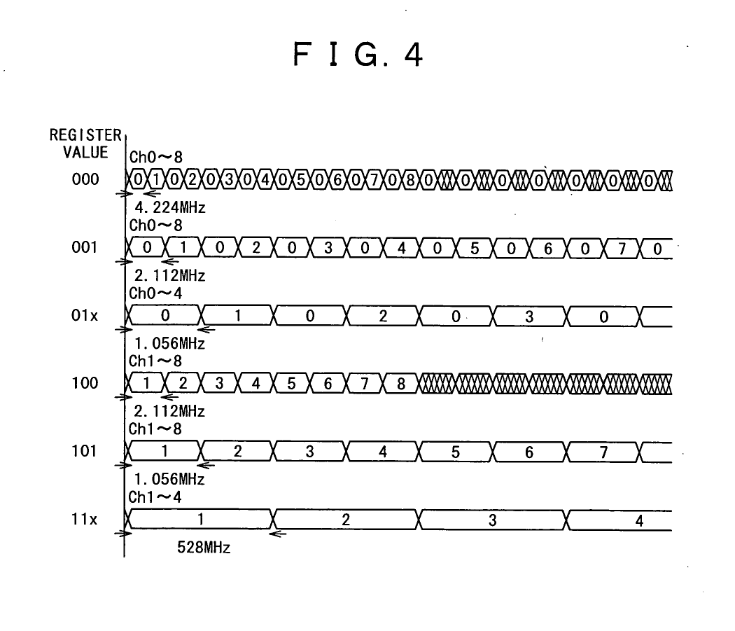

Further, the control circuit 55 has a register therein and is arranged to generate various types of control signals at a predetermined timing according to a value stored in this register as shown in FIG. 4.

For example, when “000” of a binary number is stored in the register, the first analog signal S1 inputted into the channel 0 input terminal 9 is converted to a digital signal with the sampling rate of 2.112 MHz so as to be stored in the register 46, and the first digital signal S3 is outputted through the channel 0 output terminal 28. On the other hand, the second analog signal S2, for example, inputted into the channel 1 input terminal 11 to the channel 8 input terminal 18 is converted to a digital signal with the sampling rate of 132 kHz so as to be stored in the registers 47 to 54, and the second digital signal S4 etc. are outputted through the channel 1 output terminal 29 to the channel 8 output terminal 36.

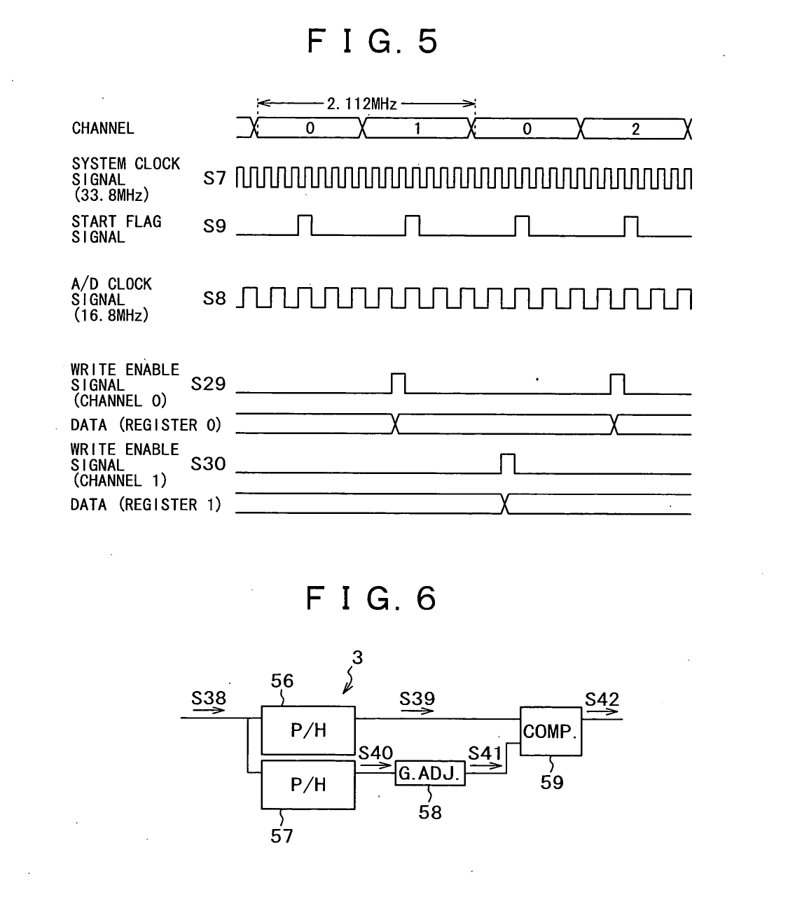

Then, as shown in FIG. 5 the variable A/D converter circuit 2 is arranged to carry out an A/D conversion at a leading edge of the start flag signal S9, and store data in the registers 46 to 54 at leading edges of the write enable signals S29 to S37 so as to be outputted through the channel 0 output terminal 28 to the channel 8 output terminal 36.

Next, the structure of the signal generation circuit 3 will be described. As shown in FIG. 6, the signal generation circuit 3 is constituted by a first peak hold circuit 56, a second peak hold circuit 57, a gain adjustment circuit 58, and a comparator circuit 59.

The first peak hold circuit 56 has the quick tracking ability with respect to an input signal S38 (the first digital signal S3 or the second digital signal S4). In other words, it is arranged to have a circuit structure being capable of tracking changes of the input signal S38 in a short time at the time of both rise and fall of the input signal S38, so as to output substantially the same detection signal S39 as the maximum of the input signal S38 (see FIGS. 7A and 7B to FIGS. 9A and 9B).

On the other hand, the second peak hold circuit 57 has the slow tracking ability with respect to the input signal S38. In other words, it is arranged to have a circuit structure which takes predetermined time (charge time and discharge time) to follow the changes of the input signal S38 at the time of both the rise and fall of the input signal S38, so as to output a detection signal S40 which rises or falls more slowly than the input signal S38 (see FIGS. 7A and 7C to FIGS. 9A and 9C).

Further, the gain adjustment circuit 58 is a circuit which divides in voltage the detection signal S40 detected in the second peak hold circuit 57 into 1/n thereof, and arranged herein to output a detection signal S41 which is divided in voltage from the detection signal S40 into one half (see FIG. 7D to FIG. 9D).

Furthermore, the comparator circuit 59 is arranged to compare the detection signal S39 detected in the first peak hold circuit 56 with the detection signal S41 divided in voltage, in the gain adjustment circuit 58, from the detection signal S40 detected in the second peak hold circuit 57, when the detection signal S39 is larger, the signal of an “L” level is outputted as an output signal S42 (the first reproduction signal S5 or the second reproduction signal S6), when the detection signal S39 is smaller, the signal of the “H” level is outputted as the output signal S42 (see FIG. 7E to FIG. 9E).

Then, as for the thus constituted signal generation circuit 3, when the first digital signal S3 based on the signal on the data recording area is used as the input signal S38, a defect signal is generated as an output signal S42 as the first reproduction signal S5. On the other hand, when the second digital signal S4 based on the signal in the burst cutting area is used as the input signal S38, the burst cutting area signal is generated as the output signal S42 as the second reproduction signal S6.

Moreover, by arranging the signal generation circuit 3 as described above, it is possible to prevent an erroneous defect detection signal from being generated, even if the bright defect occurs at the time of playback operation.

In other words, as shown in FIG. 7, in the case of the dark defect, the detection signal S39 becomes smaller than the detection signal S41 in a defective section (see FIG. 7D), so that the signal generation circuit 3 generates a correct defect signal (S42) in the defective section (see FIG. 7E).

Further, in the case of an interruption, as shown in FIG. 8 the detection signal S39 is always larger than the detection signal S41 (see FIG. 8D), so that the defect detection signal (S42) is always a signal of the “L” level (see FIG. 8E).

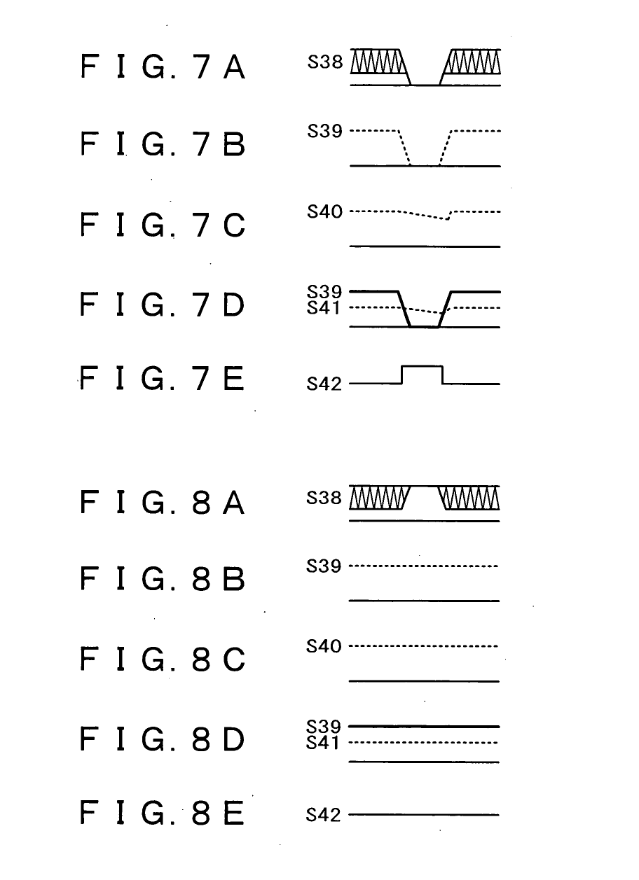

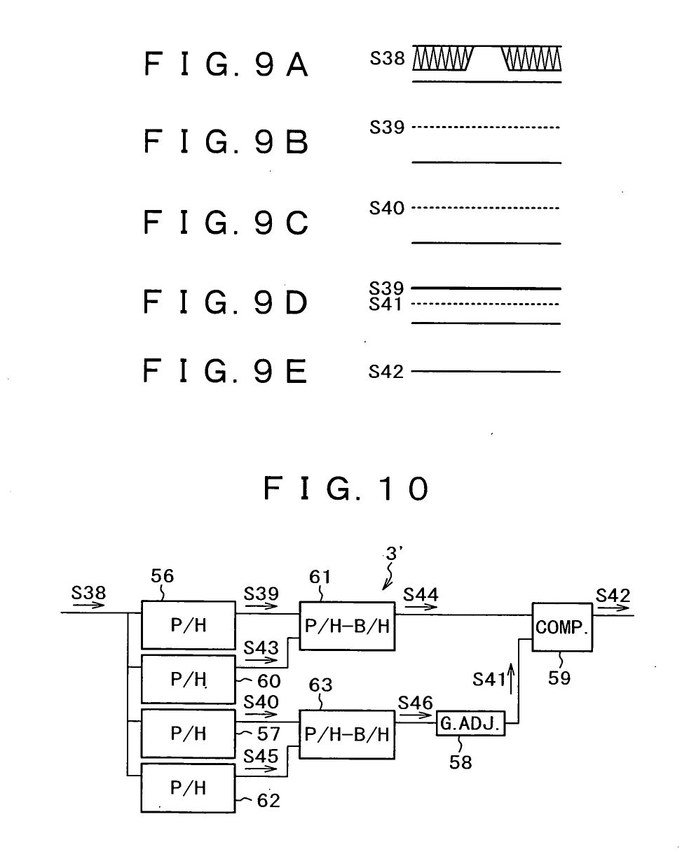

Furthermore, in the case of the bright defect, as shown in FIG. 9 the detection signal S39 is always larger than the detection signal S41 (see FIG. 9D), so that the defect detection signal (S42) is always the signal of the “L” level (see FIG. 9E).

Thus, in the conventional defect detection signal generation circuit, the defect detection signal turns into the signal of the “H” level accidentally at the time of the bright defect. According to the above-mentioned signal generation circuit 3, the defect signal does not turn into the signal of the “H” level accidentally at the time of the bright defect.

However, in the above-mentioned signal generation circuit 3, a correct defect detection signal is not necessarily generated at the time of the interruption and the bright defect.

Then, a signal generation circuit 3′ will be described which is arranged to have a circuit structure where the correct defect detection signal can be generated even at the time of the interruption and the bright defect.

The signal generation circuit 3′ is arranged to include the first peak hold circuit 56 of the above-mentioned signal generation circuit 3, the second peak hold circuit 57, the gain adjustment circuit 58, and the comparator circuit 59, and further include a first and a second bottom hold circuits 60 and 62 and a first and a second difference circuits 61 and 63.

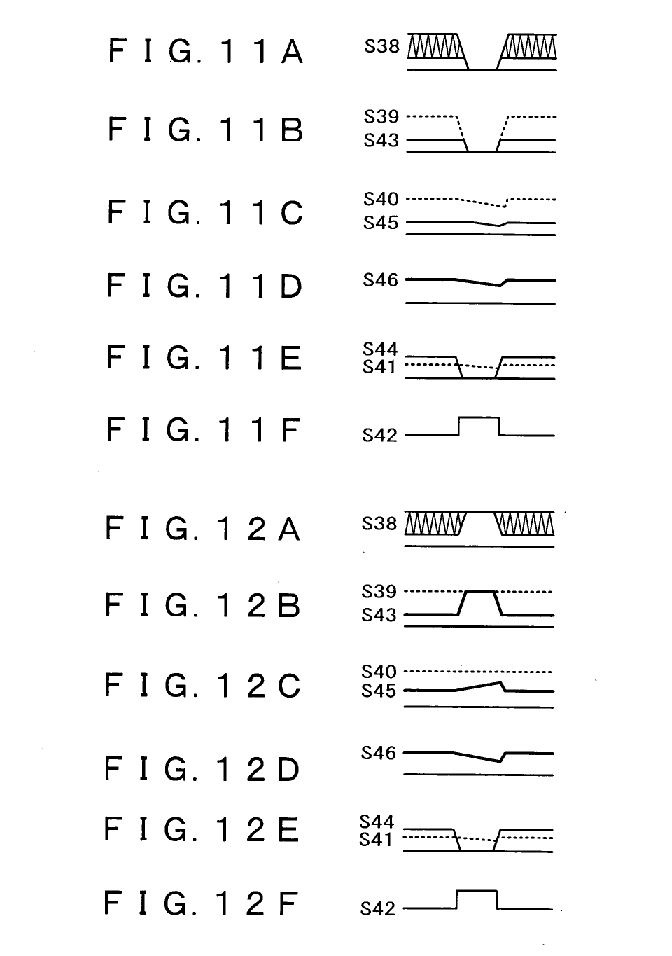

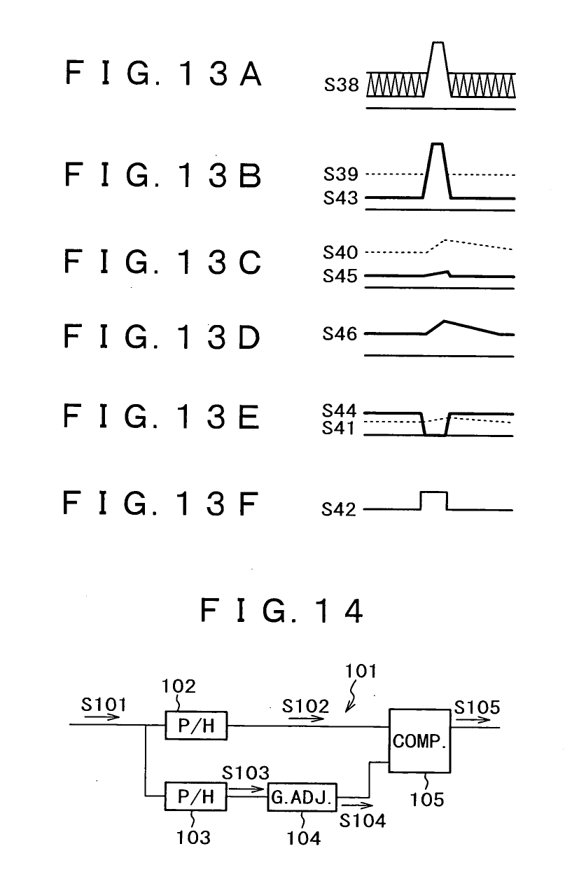

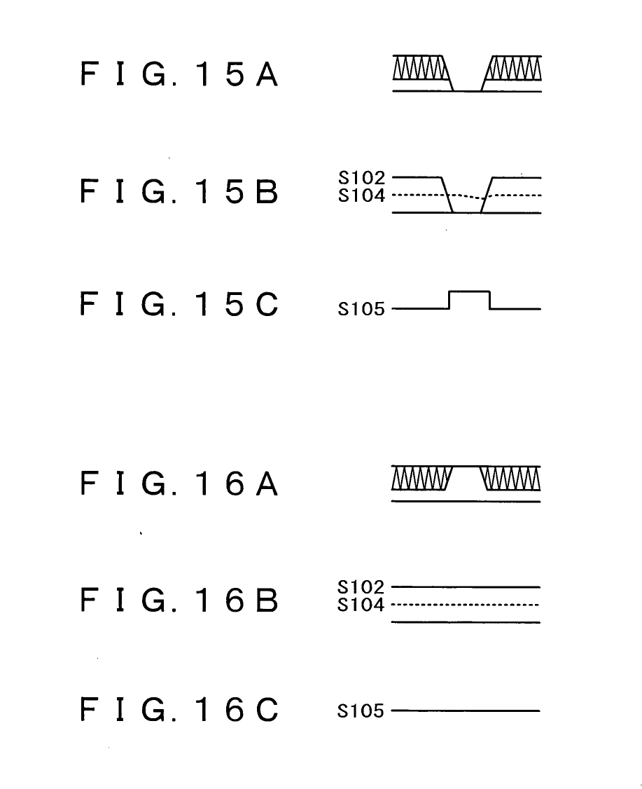

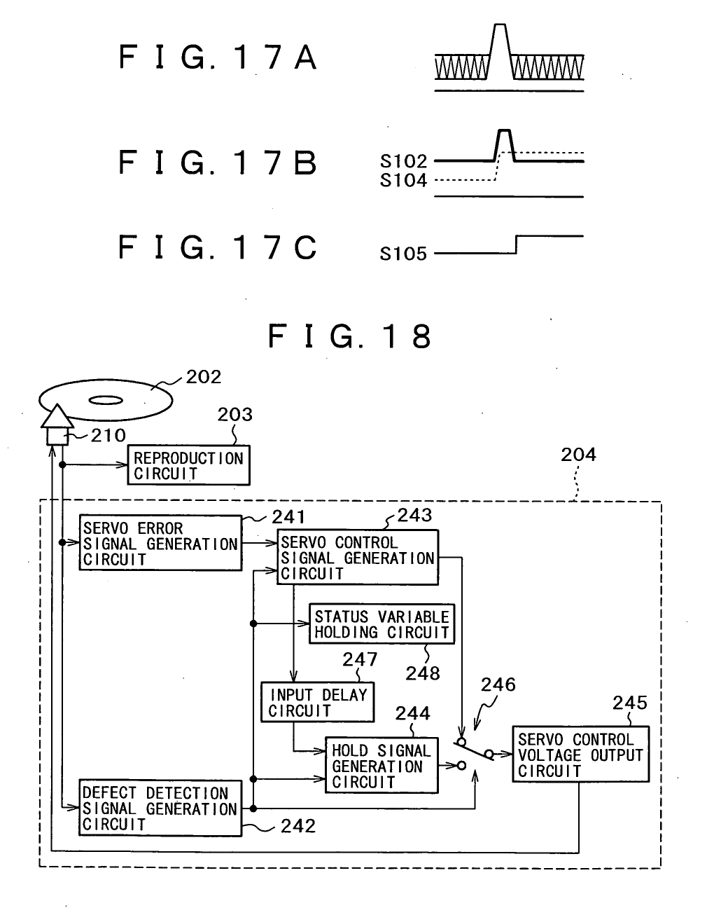

The first bottom hold circuit 60 has the quick tracking ability with respect to the input signal S38 (the first digital signal S3 or the second digital signal S4). In other words, it is arranged to have a circuit structure which is able to follow the changes of the input signal S38 in a short time at the time of both the rise and fall of the input signal S38, so as to output substantially the same detection signal S43 as the minimum of the input signal S38 (see FIGS. 11A and 11B to FIGS. 13A and 13B).

Further, the first difference circuit 61 is arranged to detect a difference between the detection signal S39 detected in the first peak hold circuit 56 and the detection signal S43 detected in the first bottom hold circuit 60 so that it is outputted as a detection signal S44 (see FIGS. 11A and 11B to FIGS. 13A and 13B).

On the other hand, the second bottom hold circuit 62 has the slow tracking ability with respect to an input signal S38. In other words, it is arranged to have a circuit structure which takes the predetermined time (charge time and the discharge time) to follow the changes of the input signal S38 at the time of both the rise and fall of the input signal S38, so as to output a detection signal S45 which rises or falls more slowly than the input signal S38 (see FIGS. 11A and 11C to FIGS. 13A and 13C).

Further, the second difference circuit 63 detects a difference between the detection signal S40 detected in the second peak hold circuit 57 and the detection signal S45 detected in the second bottom hold circuit 62 so that it is outputted as a detection signal S46 (see FIG. 11D to FIG. 13D).

Furthermore, the gain adjustment circuit 58 is a circuit which divides in voltage the detection signal S46 detected in the second difference circuit 63 into 1/n thereof, and arranged herein to output the detection signal S41 which is divided in voltage from the detection signal S46 into one half (see FIG. 11E to FIG. 13E).

Still further, the comparator circuit 59 is arranged to compare the detection signal S44 detected in the first difference circuit 61 with the detection signal S41 divided in voltage, in the gain adjustment circuit 58, from the detection signal S46 detected in the second difference circuit 63, to output the signal of the “L” level as the output signal S42 (the first reproduction signal S5 or the second reproduction signal S6) when the detection signal S44 is larger, and to further output the signal of the “H” level as the output signal S42 (see FIG. 11F to FIG. 13F) when the detection signal S44 is smaller.

Then, even if the signal generation circuit 3′ is constituted as mentioned above, as with the above-mentioned signal generation circuit 3, when the first digital signal S3 based on the signal on a data recording area is used as the input signal S38, the defect detection signal is generated as the output signal S42 as the first reproduction signal S5. On the other hand, when the second digital signal S4 based on the signal on the burst cutting area is used as the input signal S38, the burst cutting area signal is generated as the output signal S42 as the second reproduction signal S6.

Moreover, when signal generation circuit 3′is constituted as mentioned above, the correct defect detection signal can be generated not only at the time of the dark defect but also at the time of the interruption and the bright defect.

In other words, as for the signal generation circuit 3′, as shown in FIG. 11 in the case of the dark defect, the detection signal S44 becomes smaller than a detection signal S41 in the defective section (see FIG. 11E), so that the correct defect signal (S42) is generated in the defective section (see FIG. 11F).

Further, also in the case of the interruption, as shown in FIG. 12, the detection signal S44 becomes smaller than the detection signal S41 in the defective section (see FIG. 12E), so that the correct defect detection signal (S42) is generated in the defective section (see FIG. 11F).

Furthermore, in the case of the bright defect, as shown in FIG. 13, the detection signal S44 becomes smaller than the detection signal S41 in the defective section (see FIG. 13E), so that the correct defect detection signal (S42) is generated in the defective section (see FIG. 13F).

Thus, according to the above-mentioned signal generation circuit 3′, it is possible to generate the correct defect detection signal for any defect.

Further, in the optical disk device which has the servo control method, the servo control circuit, and the servo control circuit of the present invention, based on the defect detection signal generated from the output signal of the pickup unit, either the servo control signal generated from the output signal or the hold signal is chosen so as to perform the servo control of the pickup unit. In particular, when the servo control signal is changed over to the hold signal, the hold signal is generated from the servo error signal before the timing to perform the change.

In the optical disk device which has the servo control method, the servo control circuit, and the servo control circuit of the present invention, based on the defect detection signal generated from the output signal of the pickup unit, either the servo control signal generated from the output signal or the hold signal is chosen so as to perform the servo control of the pickup unit. In particular, when the servo control signal generation circuit which generates the servo control signal is connected with a status variable memory circuit which stores the status variables of the servo control signal generation circuit, and the servo control signal is changed over to the hold signal, the servo control signal generation circuit is arranged to use predetermined status variables out of the status variables stored in the status variable memory circuit.

Therefore, when the servo control of the pickup unit by means of the hold signal is changed to the servo control by means of the servo control signal, the servo control signal generation circuit resumes the generation of the servo control signal based on proper status variables, so that the normal servo control signal can be promptly outputted and the servo control can be stably performed immediately after returning from the hold state.

In other words, the hold signal is arranged to be generated by means of the servo error signal before the period of the time lag which the defect detection signal has.

Therefore, a change component produced in the servo error signal is not taken in the thus generated hold signal during the time lag of the defect detection signal, thereby generating the hold signal which can stably hold the servo of the pickup unit.

In particular, based on the defect detection signal, the status variables used at the time of resumption of the servo control signal generation are arranged to be the status variables predetermined time before the timing to change the servo control signal to the hold signal, and the predetermined time is arranged to be longer than the period of the time lag of the defect detection signal, to thereby avoid the fluctuation component of the output signal of the pickup unit from being taken in the status variables which is used by the servo control signal generation circuit so as to use the status variables which can generate the stable servo control signal.

Further, when the servo control signal is changed over to the hold signal, the hold signal generation circuit which generates the hold signal is arranged to generate the hold signal by inputting the servo error signal before the timing to perform the changeover, as the servo error signal for generating the hold signal.

In order to generate the hold signal by means of the servo error signal before the period of the time lag which the defect detection signal has, in the servo control circuit a delay circuit is provided on the input side of the hold signal generation circuit for generating the hold signal. The delay circuit outputs the servo error signal to be inputted into the hold signal generation circuit so as to be delayed by longer time than the period of the time lag which the defect detection signal has.

Therefore, the signal delayed by the predetermined time can be inputted into the hold signal generation circuit very easily, and the hold signal can be smoothly generated.

Further, the servo control signal generation circuit which generates the servo control signal is connected with the status variable memory circuit which stores the status variables of the servo control signal generation circuit. The servo control signal generation circuit is arranged to use the predetermined status variables out of the status variables stored in the status variable memory circuit, when the servo control signal is changed over to the hold signal.

Therefore, when the servo control of the pickup unit by means of the servo control signal is changed over to the servo control by means of the hold signal, the generation of the servo control signal is resumed based on the proper status variables, so that the servo control signal generation circuit may promptly output the normal servo control signal and stably perform the servo control immediately after returning from the hold state.

In particular, the status variables used at the time of resumption of the servo control signal generation are arranged to be the status variables the predetermined time before the timing to change the servo control signal to the hold signal based on a defect detection signal, and the predetermined time is arranged to be the longer time than the period of the time lag of the defect detection signal, so that the fluctuation component of the output signal of the pickup unit is avoided from being taken in the status variables which are used by the servo control signal generation circuit, and the status variables capable of generating the stable servo control signal can be used.

Based on the drawings, a preferred embodiment of the present invention will be described in detail hereafter. FIG. 18 is a block diagram for explaining a structure of a servo control circuit 204 of the preferred embodiment. For convenience of description, in this preferred embodiment, the servo control circuit 204 is a tracking servo control circuit which controls a reading point of a pickup unit 201 centering on a track of a disk 202. However, the servo control circuit is not limited to one that performs tracking servo control. It is applicable to a servo control circuit which has other servo hold functions, such as focus servo control.

A part of an RF signal which is read from the disk 202 and is inputted into a reproduction circuit 203 by the pickup unit 201 is arranged to be inputted in the servo control circuit 204.

The servo control circuit 204 is constituted by an error signal generation circuit 241 for generating a servo error signal from the RF signal which is an output signal of the pickup unit 201, a defect detection signal generation circuit 242 for generating a defect detection signal from the RF signal, a servo control signal generation circuit 243 for generating a servo control signal based on the servo error signal, a hold signal generation circuit 244 for generating the hold signal holding a constant value acquired from the servo error signal which is subjected to a wave adjustment in the servo control signal generation circuit 243, and a servo control voltage output circuit 245 for outputting a servo control voltage based on the servo control signal or the hold signal. In FIG. 18, a reference code 246 depicts a changeover switch which changes a signal to be inputted into the servo control voltage output circuit 245 based on the defect detection signal outputted from the defect detection signal generation circuit 242 according to the servo control signal and a hold signal.

An A/D converter is provided in the error signal generation circuit 241 so as to output the servo error signal which consists of a digital signal.

In the preferred embodiment, the servo error signal having been subjected to the wave adjustment in the servo control signal generation circuit 243 is arranged to be inputted into the hold signal generation circuit 244 so as not to provide the hold signal generation circuit 244 with a circuit for the wave adjustment. However, the hold signal generation circuit 244 may also be provided with the circuit for the wave adjustment, so that the servo error signal outputted from the error signal generation circuit 241 may directly be inputted into the hold signal generation circuit 244.

The input delay circuit 247 is provided on the input side of the hold signal generation circuit 244, so that the servo error signal delayed by the predetermined time may be inputted by the input delay circuit 247 into the hold signal generation circuit 244. A delay time by means of this input delay circuit 247 is considered to be T. This delay time T is considered to be time longer than the period of the time lag t which the defect detection signal generated in the defect detection signal generation circuit 242 to be mentioned later has.

Further, in the preferred embodiment a status variable memory circuit 248 in which the status variables representing a circuit state of the servo control signal generation circuit 43 are stored is connected to the servo control signal generation circuit 243. And as the status variables of the servo control signal generation circuit 243, a predetermined status variable is used out of the status variables stored in the status variable memory circuit 248, when the signal to be inputted into the servo control voltage output circuit 245 is changed from the servo control signal to the hold signal based on a defect detection signal.

Here, as the predetermined status variables, a default value may be used which is found to be capable of generating a proper servo control signal, or status variables may be used which is the predetermined time before the timing to change the servo control signal to the hold signal based on the defect detection signal. For convenience of description, this predetermined time is the same as the above-mentioned delay time T. However, this predetermined time is not necessarily the same as the delay time T. It is considered to be the longer time than the period of the time lag t which the defect detection signal generated in the defect detection signal generation circuit 242 has.

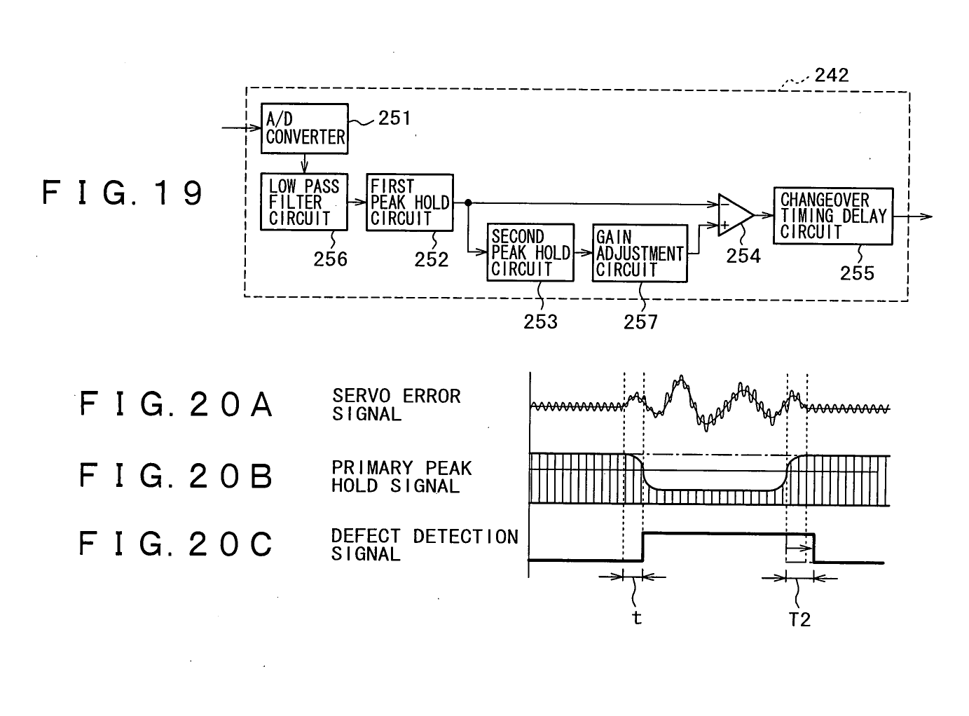

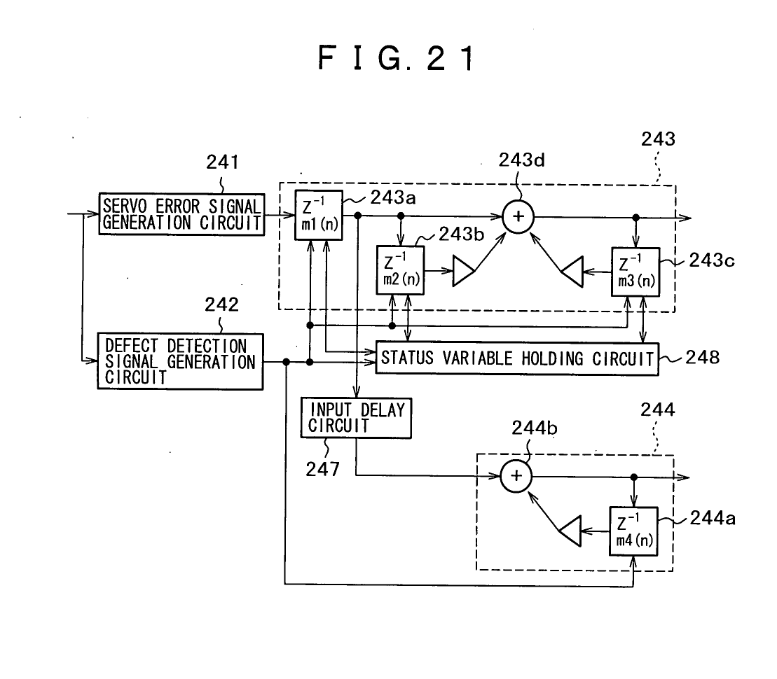

As shown in FIG. 19, the defect detection signal generation circuit 242 is constituted by an A/D converter circuit 251 for converting the analog RF signal which is the output signal of the pickup unit 1 into the digital RF signal, a first peak hold circuit 252 for generating a primary peak hold signal of the digital RF signal, a second peak hold circuit 253 for generating a secondary peak hold signal from this primary peak hold signal, a comparator circuit 254 for generating a defect detection signal based on the input of the primary peak hold signal and the secondary peak hold signal, and a changeover timing delay circuits 255 for delaying, by predetermined time, a trailing edge which determines the timing to change the input into the servo control voltage output circuit 245 from the hold signal to the servo control signal in the defect detection signal outputted from the comparator circuit 254. Here, the delay time of the trailing edge by means of the changeover timing delay circuit 255 is considered to be T′. A reference code 256 is the filter circuit provided in order to remove a pit component in the digital RF signal, and 257 is the gain adjustment circuit of the secondary peak hold signal.

In addition, the peak holds are different in tracking ability as described referring to FIG. 6. Not only the above-mentioned in-series structure but also a parallel structure in which a changeover timing delay circuit is added to FIG. 6 may be available.

By constituting the defect detection signal generation circuit 242 in this way, there is a crack or dust at the disk 202 as shown in FIG. 20, so that when a large change has arisen in the servo error signal generated from the output signal of the pickup unit 201 as shown in FIG. 20A, a level fall due to the level fall in the output signal of the pickup unit 1 arises in the primary peak hold signal in the defect detection signal generation circuit 242 as shown in FIG. 20B, whereby the defect detection signal as shown in FIG. 20C can be generated and outputted.

As with a conventional one, in this defect detection signal, there is the time lag t which is a period of time from a level of the primary peak hold signal starting to fall until it falls below the threshold level.

And, there is conventionally a time lag also in the trailing-edge section of the defect detection signal for substantially the same period as this time lag t. When the signal to be inputted into the servo control voltage output circuit 45 is changed from the hold signal to the servo control signal based on a defect detection signal by delaying the trailing edge by delay time T′ longer than the time lag t by means of the changeover timing delay circuit 55, the servo control signal is generated by the servo control signal generation circuit 243 based on a normal servo error signal, whereby the servo control can be stably performed immediately after returning from the hold state.

In the last instance, operation of the input delay circuit 247 and the status variable memory circuit 248 will be described in detail.

Firstly, in the preferred embodiment, as shown in FIG. 4 the servo control signal generation circuit 243 employs a loop filter constituted by a first circuit element 243a in which a first status variable m1(n) is stored, a second circuit element 243b in which a second status variable m2(n) is stored, a third circuit element 243c in which a third status variable m3(n) is stored, and a first addition circuit 243d.

Further, the hold signal generation circuit 244 employs a low pass filter constituted by a fourth circuit element 244a in which a fourth status variable m4(n) is stored and a second addition circuit 244b.

For convenience of description, it will be described by means of using discrete time through Z conversion. In particular, time in the control circuit is represented by discrete time based on a servo error signal.

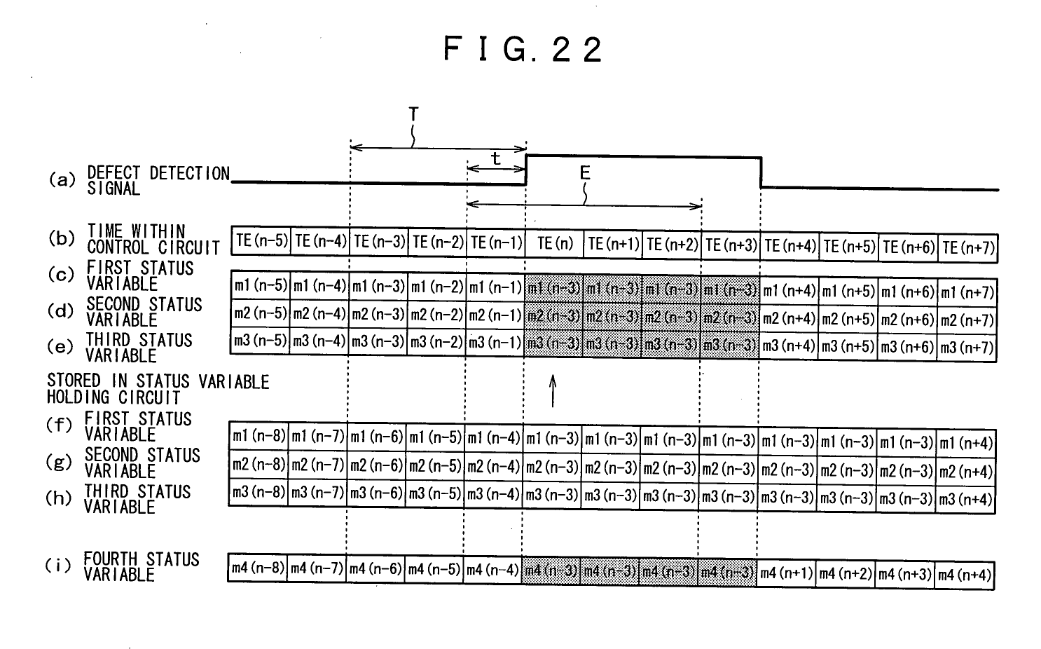

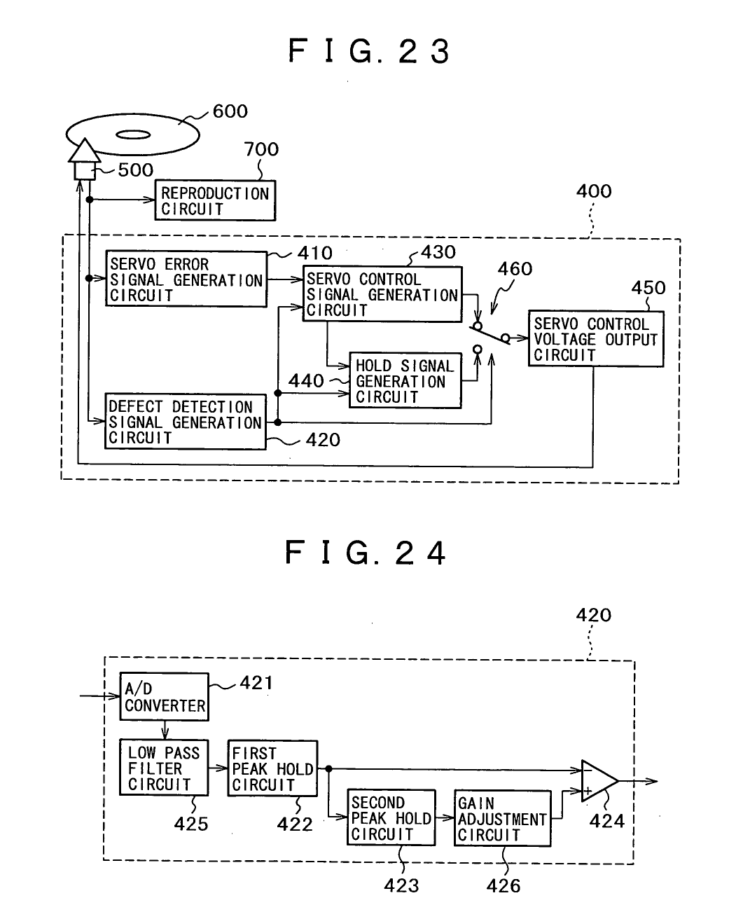

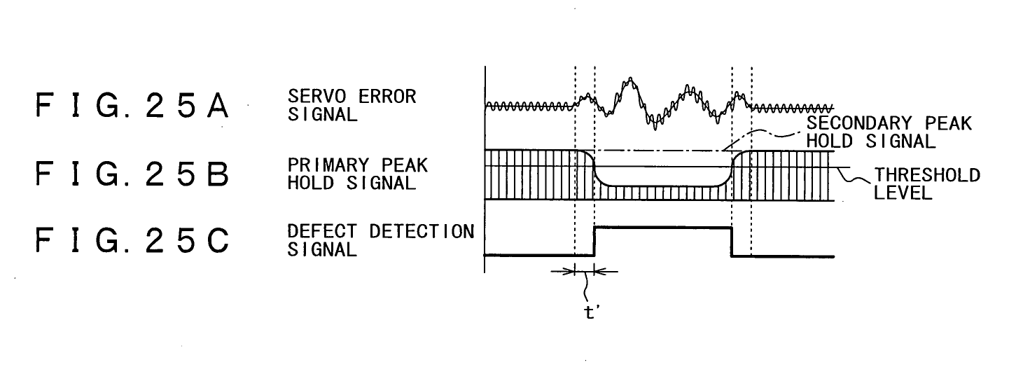

Then, as shown by a chart (a) in FIG. 22, assuming that the defect detection signal is generated during a period from time TE(n) to time TE(n+3), an abnormal state period E is between time TE(n−1) and time TE(n+2), as shown by a chart (b) in FIG. 22.

A chart (c) in FIG. 22 shows a change of the first status variable m1(n) in the first circuit-element 43a, a chart (d) in FIG. 22 shows a change of the second status variable m2(n) in the second circuit-element 43b, and a chart (e) in FIG. 22 shows a change of the third status variable m3(n) in the third circuit-element 43c.

A chart (f) in FIG. 22 shows a change of the first status variable m1(n) stored in a status variable memory circuit 48, a chart (g) in FIG. 22 shows a change of the second status variable m2(n) stored in the status variable memory circuit 48, and a chart (h) FIG. 22 shows a change of the third status variable m3(n) stored in the status variable memory circuit 48.

In the preferred embodiment, as shown in FIG. 22, the status variable m1(n), m2(n), and m3(n), which are the predetermined time earlier, of the first circuit element 243a, the second circuit element 243b, and the third circuit element 243c, are arranged to be respectively stored in the status variable memory circuit 248, where the predetermined time is arranged to be the same as the above-mentioned delay time T.

And, as shown in FIG. 22, when the signal to be inputted into the servo control voltage output circuit 245 is changed at time TE(n) from the servo control signal to the hold signal based on the defect detection signal, the status variables then stored in the status variable memory circuit 248 is arranged to be inputted into each of the circuit elements 243a, 243b, and 243c of the servo control signal generation circuit 243.

Since the predetermined time T is arranged to be the longer time than the period of the time lag t which the defect detection signal generated in the defect detection signal generation circuit 242 has, it is possible to prevent the status variables m1(n−3), m2(n−3), and m3(n−3) respectively inputted into the circuit elements 243a, 243b, and 243c from containing the fluctuation component due to the change of the servo error signal.

Therefore, when the servo control based on a servo control signal is restarted with the hold of the pickup unit 1 based on a hold signal, the servo control signal generation circuit 243 resumes the generation of the servo control signal based on the proper status variables, so that the normal servo control signal can be promptly outputted and the servo control can be stably performed immediately after returning from the hold state.

In addition, when the status variables are found in advance which allows the normal servo control signal to be generated, the status variables may be inputted.

Further, as other preferred embodiments, the status variables m1(n), m2(n), and m3(n), at the time, of the first circuit element 243a, the second circuit element 243b, and the third circuit element 243c are arranged to be respectively stored in the status variable memory circuit 248. When the signal to be inputted into the servo control voltage output circuit 245 at time TE(n) is changed from the servo control signal to the hold signal, the status variables stored in the status variable memory circuit 248, which is the predetermined time earlier, may be read and inputted into each of the circuit elements 243a, 243b, and 243c of the servo control signal generation circuit 243.

When the signal to be inputted into the servo control voltage output circuit 245 at time TE(n) is changed from the servo control signal to the hold signal, the status variable memory circuit 248 suspends storing the status variables of each of the circuit elements 243a, 243b, and 243c, so as to hold the status variables stored at time TE(n). And, the status variable memory circuit 248 is arranged to resume storing the status variables after the abnormal state period E has elapsed.

A chart (j)) in FIG. 22 shows a change of the fourth status variable m4(n) in the fourth circuit-element 244a of the hold signal generation circuit 244. Since the servo error signal delayed by the delay time T longer than the period of time lag t by means of the input delay circuit 247 is arranged to be inputted into the hold signal generation circuit 244, the servo error signal which has not produced a change can be inputted into the hold signal generation circuit 244, when the signal to be inputted into the servo control voltage output circuit 245 based on the defect detection signal is changed from a servo control signal to a hold signal, thus generating the hold signal which does not contain a fluctuation component. Therefore, it is possible to generate the hold signal which can hold the servo of the pickup unit stably.

1. A servo control method comprising the steps of:
generating a servo error signal and a defect detection signal from an output signal of a pickup unit;
generating a servo control signal and a hold signal from said servo error signal; and
carrying out a servo control of said pickup unit by changing over to either said servo control signal or said hold signal based on said defect detection signal, wherein;
when said servo control signal is changed over to said hold signal, said hold signal is generated from said servo error signal of before the timing to change.

2. A servo control method comprising the steps of:
generating a servo control signal, a hold signal, and a defect detection signal from an output signal of a pickup unit; and
carrying out a servo control of said pickup unit by changing over to either said servo control signal or said hold signal based on the defect detection signal, wherein;
status variables of the servo control signal generation circuit which generates said servo control signal are stored in a status variable memory circuit; and
said servo control signal generation circuit uses a predetermined status variable out of said status variables stored in said status variable memory circuit, when said servo control signal is changed over to said hold signal.

3. A servo control method comprising the steps of:
generating a servo control signal, a hold signal, and a defect detection signal from an output signal of a pickup unit; and
carrying out a servo control of said pickup unit by changing over to either said servo control signal or said hold signal based on the defect detection signal, wherein;
when said servo control signal is changed over to said hold signal, said hold signal is generated from said servo error signal of before the timing to change;
status variables of a servo control signal generation circuit which generates said servo control signal are stored in a status variable memory circuit; and
when said servo control signal is changed over to said hold signal, said servo control signal generation circuit uses a predetermined status variable out of said status variables stored in said status variable memory circuit.

4. A servo control circuit which generates a servo control signal, a hold signal, and a defect detection signal from an output signal of a pickup unit, and changes over to either said servo control signal or said hold signal based on the defect detection signal so as to perform a servo control of said pickup unit; said servo control circuit further comprising:
a delay circuit on an input side of a hold signal generation circuit for generating said hold signal.

5. The servo control circuit as claimed in claim 4, wherein;
a defect detection signal generation circuit which generates said defect detection signal comprises:
a first and a second signal detection circuits having different tracking ability at the time of a rise and fall of the output signal of said pickup unit; and
a first and a second detection signals detected in the first and the second signal detection circuits are compared to generate a defect detection signal.

6. The servo control circuit as claimed in claim 5, wherein;
a first peak hold circuit having quick tracking ability with respect to said input signal is used as said first signal detection circuit; and
a second peak hold circuit having slow tracking ability with respect to said input signal is used as said second signal detection circuit.

7. The servo control circuit as claimed in claim 5, wherein;
said first signal detection circuit includes;
the first peak hold circuit having the quick tracking ability with respect to said input signal;
a first bottom hold circuit having the quick tracking ability with respect to said input signal, and
a first difference circuit for detecting a difference between a detection signal in said first peak hold circuit and a detection signal in said first bottom hold circuit; and
said second signal detection circuit includes;
the second peak hold circuit having the slow tracking ability with respect to said input signal;
a second bottom hold circuit having the slow tracking ability with respect to said input signal; and
a second difference circuit for detecting a difference between a detection signal in said second peak hold circuit and a detection signal in said second bottom hold circuit.

8. The servo control circuit as claimed in claim 4, 5, 6, or 7, wherein;
said defect detection signal generation circuit for generating said defect detection signal includes a changeover timing delay circuit for delaying a timing to change said hold signal to said servo control signal based on said defect detection signal.

9. A servo control circuit which generates a servo control signal, a hold signal, and a defect detection signal from an output signal of a pickup unit, and changes over to either said servo control signal or said hold signal based on the defect detection signal so as to perform servo control of said pickup unit, wherein;
a status variable memory circuit for storing a status variables of the servo control signal generation circuit is connected to a servo control signal generation circuit which generates said servo control signal; and
said servo control signal generation circuit is arranged to use a predetermined status variable out of said status variables stored in said status variable memory circuit, when said servo control signal is changed to said hold signal.

10. The servo control circuit as claimed in claim 9, wherein;
the defect detection signal generation circuit which generates said defect detection signal further comprises:
a first and a second signal detection circuits having different tracking ability at the time of a rise and fall of the output signal of said pickup unit, wherein;
a first and a second detection signals detected in the first and the second signal detection circuits are compared to generate a defect detection signal.

11. The servo control circuit as claimed in claim 10, wherein;
a first peak hold circuit having quick tracking ability with respect to said input signal is used as said first signal detection circuit; and
a second peak hold circuit having slow tracking ability with respect to said input signal is used as said second signal detection circuit.

12. The servo control circuit as claimed in claim 10, wherein;
said first signal detection circuit includes;
the first peak hold circuit having the quick tracking ability with respect to said input signal;
a first bottom hold circuit having the quick tracking ability with respect to said input signal; and
a first difference circuit for detecting a difference between a detection signal in said first peak hold circuit and a detection signal in said first bottom hold circuit; and
said second signal detection circuit includes;
the second peak hold circuit having the slow tracking ability with respect to said input signal;
a second bottom hold circuit having the slow tracking ability with respect to said input signal; and
a second difference circuit for detecting a difference between a detection signal in said second peak hold circuit and a detection signal in said second bottom hold circuit.

13. The servo control circuit as claimed in claim 9, 10, 11 or 12, wherein;
said status variables used by said servo control signal generation circuit are status variables which are stored predetermined time before the timing to change said servo control signal to said hold signal based on said defect detection signal.

14. The servo control circuit as claimed in claim 9, 10, 11 or 12, wherein;
a changeover timing delay circuit is provided in the defect detection signal generation circuit which generates said defect detection signal; and
said changeover timing delay circuit delays a timing to change said hold signal to said servo control signal based on said defect detection signal.

15. The servo control circuit as claimed in claim 13, wherein;
a changeover timing delay circuit is provided in the defect detection signal generation circuit which generates said defect detection signal; and
said changeover timing delay circuit delays a timing to change said hold signal to said servo control signal based on said defect detection signal.

16. A servo control circuit which generates a servo control signal, a hold signal, and a defect detection signal from an output signal of a pickup unit, and changes over to either said servo control signal or said hold signal based on the defect detection signal so as to perform servo control of said pickup unit, wherein;
a delay circuit is provided on an input side of a hold signal generation circuit for generating said hold signal;
a status variable memory circuit which stores status variables of this servo control signal generation circuit is connected to a servo control signal generation circuit which generates said servo control signal; and
said servo control signal generation circuit is arranged to use a predetermined status variables out of said status variables stored in said status variable memory circuit, when said servo control signal is changed over to said hold signal.

17. The servo control circuit as claimed in claim 16, wherein;
the defect detection signal generation circuit which generates said defect detection signal comprises:
a first and a second signal detection circuits having different tracking ability at the time of a rise and fall of the output signal of said pickup unit; wherein;
a first and a second detection signals detected in the first and the second signal detection circuits are compared to generate a defect detection signal.

18. The servo control circuit as claimed in claim 17, wherein;
a first peak hold circuit having quick tracking ability with respect to said input signal is used as said first signal detection circuit; and
a second peak hold circuit having slow tracking ability with respect to said input signal is used as said second signal detection circuit.

19. The servo control circuit as claimed in claim 17, wherein;
said first signal detection circuit includes;
the first peak hold circuit having the quick tracking ability with respect to said input signal;
a first bottom hold circuit having the quick tracking ability with respect to said input signal, and
a first difference circuit for detecting a difference between a detection signal in said first peak hold circuit and a detection signal in said first bottom hold circuit; and
said second signal detection circuit includes;
the second peak hold circuit having the slow tracking ability with respect to said input signal;
a second bottom hold circuit having the slow tracking ability with respect to said input signal; and
a second difference circuit for detecting a difference between a detection signal in said second peak hold circuit and a detection signal in said second bottom hold circuit.

20. The servo control circuit as claimed in claim 16, 17, 18, or 19, wherein;
said status variables used by said servo control signal generation circuit are status variables which are stored predetermined time before a timing to change said servo control signal to said hold signal based on said defect detection signal.

21. An optical disk device having a servo control circuit which generates a servo control signal, a hold signal, and a defect detection signal from an output signal of a pickup unit, and changes over to either said servo control signal or said hold signal based on the defect detection signal so as to perform servo control of said pickup unit; said servo control circuit further comprising:
a delay circuit is provided on an input side of a hold signal generation circuit for generating said hold signal.

22. The optical disk device as claimed in claim 21, wherein;
the defect detection signal generation circuit which generates said defect detection signal comprises;
a first and a second signal detection circuits having different tracking ability at the time of a rise and fall of the output signal of said pickup unit; wherein
a first and a second detection signals detected in the first and the second signal detection circuits are compared to generate a defect detection signal.

23. The optical disk device as claimed in claim 22, wherein;
a first peak hold circuit having quick tracking ability with respect to said input signal is used as said first signal detection circuit; and
a second peak hold circuit having slow tracking ability with respect to said input signal is used as said second signal detection circuit.

24. The optical disk device as claimed in claim 22, wherein;
said first signal detection circuit includes;
the first peak hold circuit having the quick tracking ability with respect to said input signal;
a first bottom hold circuit having the quick tracking ability with respect to said input signal; and
a first difference circuit for detecting a difference between a detection signal in said first peak hold circuit and a detection signal in said first bottom hold circuit; and
said second signal detection circuit includes;
the second peak hold circuit having the slow tracking ability with respect to said input signal;
a second bottom hold circuit having the slow tracking ability with respect to said input signal; and
a second difference circuit for detecting a difference between a detection signal in said second peak hold circuit and a detection signal in said second bottom hold circuit.

25. The optical disk device as claimed in claim 21, 22, 23, or 24, wherein;
a changeover timing delay circuit is provided in the defect detection signal generation circuit which generates said defect detection signal; and
said changeover timing delay circuit delays a timing to change said hold signal to said servo control signal based on said defect detection signal.

26. An optical disk device having a servo control circuit which generates a servo control signal, a hold signal, and a defect detection signal from an output signal of a pickup unit, and changes over to either said servo control signal or said hold signal based on the defect detection signal so as to perform servo control of said pickup unit, wherein;
a status variable memory circuit which stores the status variables of the servo control signal generation circuit is connected to the servo control signal generation circuit which generates said servo control signal; and
said servo control signal generation circuit is arranged to use a predetermined status variable out of said status variables stored in said status variable memory circuit, when said servo control signal is changed over to said hold signal.

27. An optical disk device having a servo control circuit which generates a servo control signal, the hold signal, and a defect detection signal from an output signal of a pickup unit, and changes over to either said servo control signal or said hold signal based on the defect detection signal so as to perform servo control of said pickup unit, wherein;
a delay circuit is provided on an input side of a hold signal generation circuit for generating the hold signal.

28. The optical disk device as claimed in claim 26, wherein;
the defect detection signal generation circuit which generates said defect detection signal comprises;
a first and a second signal detection circuits having different tracking ability at the time of a rise and fall of the output signal of said pickup unit; and
a first and a second detection signals detected in the first and the second signal detection circuits are compared to generate a defect detection signal.

29. The optical disk device as claimed in claim 27, wherein;
a first peak hold circuit having quick tracking ability with respect to said input signal is used as said first signal detection circuit; and
a second peak hold circuit having slow tracking ability with respect to said input signal is used as said second signal detection circuit.

30. The optical disk device as claimed in claim 27, wherein;
said first signal detection circuit includes;
the first peak hold circuit having the quick tracking ability with respect to said input signal;
a first bottom hold circuit having the quick tracking ability with respect to said input signal; and
a first difference circuit for detecting a difference between a detection signal in said first peak hold circuit and a detection signal in said first bottom hold circuit; and
said second signal detection circuit includes;
the second peak hold circuit having the slow tracking ability with respect to said input signal;
a second bottom hold circuit having the slow tracking ability with respect to said input signal; and
a second difference circuit for detecting a difference between a detection signal in said second peak hold circuit and a detection signal in said second bottom hold circuit.

31. The optical disk device as claimed in claim 27, 28, 29 or 30, wherein;
said status variables used by said servo control signal generation circuit are status variable which are stored predetermined time before a timing to change said servo control signal to said hold signal based on said defect detection signal.

32. The optical disk device as claimed in claim 27, 28, 29 or 30, wherein;
a changeover timing delay circuit is provided in the defect detection signal generation circuit which generates said defect detection signal; and
said changeover timing delay circuit delays a timing to change said hold signal to said servo control signal based on said defect detection signal.

33. The optical disk device as claimed in claim 31, wherein;
a changeover timing delay circuit is provided in the defect detection signal generation circuit which generates said defect detection signal; and
said changeover timing delay circuit delays a timing to change said hold signal to said servo control signal based on said defect detection signal.

34. An optical disk device having a servo control circuit which generates a servo control signal, a hold signal, and a defect detection signal from an output signal of a pickup unit, and changes over to either said servo control signal or said hold signal based on the defect detection signal so as to perform servo control of said pickup unit, wherein said servo control circuit includes;
a delay circuit which is provided on an input side of a hold signal generation circuit for generating said hold signal; and
a status variable memory circuit which stores status variables of the servo control signal generation circuit is connected to the servo control signal generation circuit which generates said servo control signal, wherein;
said servo control signal generation circuit is arranged to use a predetermined status variable out of said status variables stored in said status variable memory circuit, when said servo control signal is changed over to said hold signal.

35. The optical disk device as claimed in claim 34, wherein;
the defect detection signal generation circuit which generates said defect detection signal comprises;
a first and a second signal detection circuits having different tracking ability at the time of a rise and fall of the output signal of said pickup unit, wherein;
a first and a second detection signals detected in the first and the second signal detection circuits are compared to generate a defect detection signal.

36. The optical disk device as claimed in claim 35, wherein;
a first peak hold circuit having quick tracking ability with respect to said input signal is used as said first signal detection circuit; and
a second peak hold circuit having slow tracking ability with respect to said input signal is used as said second signal detection circuit.

37. The optical disk device as claimed in claim 35, wherein;
said first signal detection circuit includes;
the first peak hold circuit having the quick tracking ability with respect to said input signal;
a first bottom hold circuit having the quick tracking ability with respect to said input signal;
and a first difference circuit for detecting a difference between a detection signal in said first peak hold circuit and a detection signal in said first bottom hold circuit; and
said second signal detection circuit includes;
the second peak hold circuit having the slow tracking ability with respect to said input signal;
a second bottom hold circuit having the slow tracking ability with respect to said input signal;
and a second difference circuit for detecting a difference between a detection signal in said second peak hold circuit and a detection signal in said second bottom hold circuit.

38. The optical disk device as claimed in claim 34, 35, 36 or 37, wherein;
said status variables used by said servo control signal generation circuit are status variable which are stored predetermined time before a timing to change said servo control signal to said hold signal based on said defect detection signal.

39. The optical disk device as claimed in claim 34, 35, 36 or 37, wherein;
a changeover timing delay circuit is provided in the defect detection signal generation circuit which generates said defect detection signal; and
said changeover timing delay circuit delays a timing to change said hold signal to said servo control signal based on said defect detection signal.

40. The optical disk device as claimed in claim 38, wherein;
a changeover timing delay circuit is provided in the defect detection signal generation circuit which generates said defect detection signal; and
said changeover timing delay circuit delays a timing to change said hold signal to said servo control signal based on said defect detection signal.
